(19) United States
(12) Patent Application Publication
(10) Pub. No.: US 2016/0332538 A1
(43) Pub. Date: Nov. 17, 2016

(54) REAR PASSENGER INGRESS/EGRESS AND METHODS

(71) Applicant: FORD GLOBAL TECHNOLOGIES, LLC, Dearborn, MI (US)

(72) Inventors: Arlindo Rocha, Kingsville Ontario (CA); Hubert Szawarski, Waterford, MI (US); Mark A. Cuddihy, New Boston, MI (US)

(21) Appl. No.: 14/713,607

(22) Filed: May 15, 2015

(51) Int. Cl. B60N 2/02; B60N 2/06

(52) U.S. Cl. CPC B60N 2/0244; B60N 2/06; B60N 2/0228; B60N 2002/0256; B60N 2002/0268

(57) ABSTRACT

A seat repositioning system for improving rear passenger ease of entry/exit to and from vehicle includes at least a seat position controller and associated logic for controlling movement of a front seat of the vehicle. The position controller is configured to cause at least a portion of a displaceable front seat of the vehicle to move forwardly when the system is enabled. The position controller may also prevent or limit rearward movement of one or more displaceable front seats of the vehicle. An actuator is provided for enabling/disabling the described system.

### TECHNICAL FIELD

This disclosure relates generally to adjustable seats for motor vehicles. More particularly, the disclosure relates to a control system for adjusting a position of vehicle front seating in order to facilitate rear passenger ingress to/egress from the vehicle.

### BACKGROUND

It is known to provide motor vehicle seats which automatically adjust under a number of circumstances. For example, a vehicle driver's seat may be configured to automatically adjust to various driver preset conditions (“presets”), such as a desired longitudinal distance from the vehicle dash panel and steering wheel, a seat bottom height, a seat back orientation (tilt, recline, etc.), and others. This is often accomplished by an operator actuating dedicated buttons associated with the vehicle dash panel or door. Still more, it is known to store specific operator identification codes, for example in a vehicle key fob. On insertion of the key into the vehicle ignition, or simply in accordance with detection of the presence of the key fob in the vehicle and detection of the presence of the operator in the vehicle seat by way of an occupant presence sensor, the operator identification code is correlated with various presets for the vehicle seat as summarized above, and seat positioning devices adjust the various components of the vehicle seat vertically and/or laterally to the operator's liking according to the presets.

In turn, it is known to provide manual and automated adjustment of a vehicle front seat or seats in order to provide increased legroom and so facilitate driver and/or passenger ingress to and egress from a vehicle back seat or seats. At a high level, systems and mechanisms are known which automatically reposition the vehicle front seat or seats, or portions thereof, forwardly in a longitudinal direction towards the vehicle dash panel on receipt of a predetermined signal that an occupant of the vehicle rear seat wishes to exit the vehicle, or that a passenger wishes to sit down the vehicle rear seat. Likewise, systems are known which automatically reposition the vehicle front seat rearwardly in a longitudinal direction towards the vehicle rear seats on receipt of a predetermined signal, such as on vehicle shutdown, to increase the space available for a driver or front seat passenger to enter/exit the vehicle. Such systems can variously employ front and/or rear seat passenger occupant detectors, vehicle rear door status sensors, engine status sensors, etc. to provide necessary information determining which vehicle seat requires repositioning and in what direction to facilitate front or rear seat ingress/egress.

While effective for their intended purpose and convenient, such systems create unintended consequences. For example, a vehicle front seat repositioning system which repositions a vehicle front seat according to operator presets may unduly reduce the legroom available to a passenger, especially if the occupant of the front seat is very tall. Further, a system as described above for automatically repositioning a vehicle front seat to facilitate front seat entry/exit may not take into account the presence of passengers in the rear seat, likewise causing inconvenience to such passengers. For example, due to lack of space, removing a child from a child seat positioned in the vehicle rear seat can be difficult or inconvenient when a front seat is automatically repositioned rearwardly Likewise, automatic rearward repositioning of a front seat could cause discomfort to a child in a child seat placed in the rear row.

To solve this and other problems, the present disclosure relates at a high level to a system and associated devices and controllers for limiting rearward movement of a vehicle front seat when passengers are occupying or about to occupy a vehicle rear seat. Advantageously, the described seat repositioning system integrates with existing vehicle seat repositioning systems as described above, but provides additional convenience for rear seat occupants.

### SUMMARY

In accordance with the purposes and benefits described herein, in one aspect seat repositioning systems for a vehicle are described comprising a position controller configured to, when enabled, automatically control a movement of one or more front seats of the vehicle to provide a rear seat easy entry/exit function. In an embodiment, a rear door state sensor is provided which outputs a signal in response to opening or unlocking a rear door of the vehicle, as indicative of a passenger requiring the rear seat easy entry/exit feature.

The position controller, when enabled, causes at least a portion of a front seat of the vehicle to move forwardly when a front seat occupant sensor associated with the front seat does not detect a front seat occupant, providing the rear seat easy entry/exit function. In an embodiment, when enabled the position controller prevents or limits rearward movement of the front seat to a predetermined or preset threshold. An actuator is provided, configured for enabling or disabling the position controller. In embodiments, the actuator is one or more of a switch, a display console or instrument cluster menu button, and a key fob.

In another aspect, a method is described for improving ease of entry to and/or exit from a rear seat of a vehicle. The steps of the method include providing a position controller configured to, when enabled, automatically control a movement of one or more front seats of the vehicle to provide a rear seat easy entry/exit function as described above.

In the following description, there are shown and described embodiments of the disclosed seat repositioning system. As it should be realized, the system is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed seat repositioning system, and together with the description serve to explain certain principles thereof. In the drawing:

FIG. 1 depicts a motor vehicle including a prior art seat repositioning system;

FIG. 2 depicts a motor vehicle including a seat repositioning system according to the present disclosure;

FIG. 3 depicts a motor vehicle including a seat repositioning system according to the present disclosure providing a predetermined threshold for rearward movement of a front seat;

FIG. 4 depicts a user interface for control of the seat repositioning system of the present disclosure;

FIG. 5 depicts in flow chart form a method for improving passenger rear seat ingress/egress by the seat repositioning system depicted in FIG. 2; and

FIG. 6 depicts in flow chart form a method for improving passenger rear seat ingress/egress by the seat repositioning system depicted in FIG. 3.

Reference will now be made in detail to embodiments of the disclosed seat repositioning system, examples of which are illustrated in the accompanying drawing figures.

### DETAILED DESCRIPTION

Preliminarily, systems, methods, and devices/mechanisms for altering the forward and rearward positioning of vehicle seats and portions of vehicle seats are well known in the art, and so are not described in detail herein Likewise, various sensors and detectors for determining a presence of a vehicle seat occupant and/or for determining a state of a vehicle door (open or closed) are also well known and need not be described in detail hereon. U.S. Published Patent Appl. No. 2014/0316660, owned by the present assignee Ford Global Technologies, LLC, provides examples of such devices and methods, and is incorporated herein by reference as if fully restated.

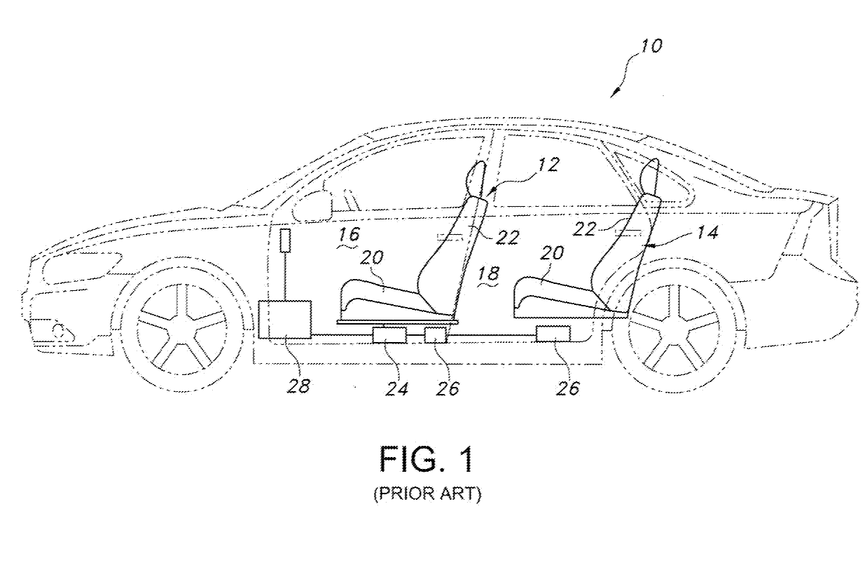

Turning now to FIG. 1, a representative motor vehicle 10 is depicted including at least one front seat 12, one rear seat 14, and corresponding front and rear vehicle doors 16, 18. Front and rear seats 12, 14 may be defined by a seat bottom 20 and a seat back 22. As is known and as briefly summarized above, front seat 12 may be configured for adjustability, that is, for movement in a forward and/or rearward direction relative to the orientation of vehicle 10. Likewise, front seat 12 may be further adjustable by altering an angle and/or a height of seat bottom 20, and by altering an angle of seat back 22 in a forward or rearward direction. Mechanisms for accomplishing such adjustments are known in the art.

In turn, front seats 12 may be equipped with sensors (depicted generally by reference numeral 24) for detecting the presence of a front seat occupant. Such seat sensors may be as simple as a pressure switch embedded in the seat for detecting the weight of a passenger, or may be more complex mechanisms. Doors 16, 18 may be equipped with door state sensors (depicted generally by reference numeral 26) for detecting a state of the door (i.e., open or closed). Again, such door sensors may be as simple as a pressure switch that is closed by a portion of the door when the door is placed in a closed configuration and released when the door is opened, or may be more complex and/or associated with other components of vehicle 10, such as the rear door locks. Signals output by sensors 24, 26 may be received by a controller 28, which in turn may be configured to direct other vehicle components, for example, to display a “door ajar” warning in the vehicle instrument panel (not shown) when sensor 26 has detected that a vehicle door 16 or 18 is open.

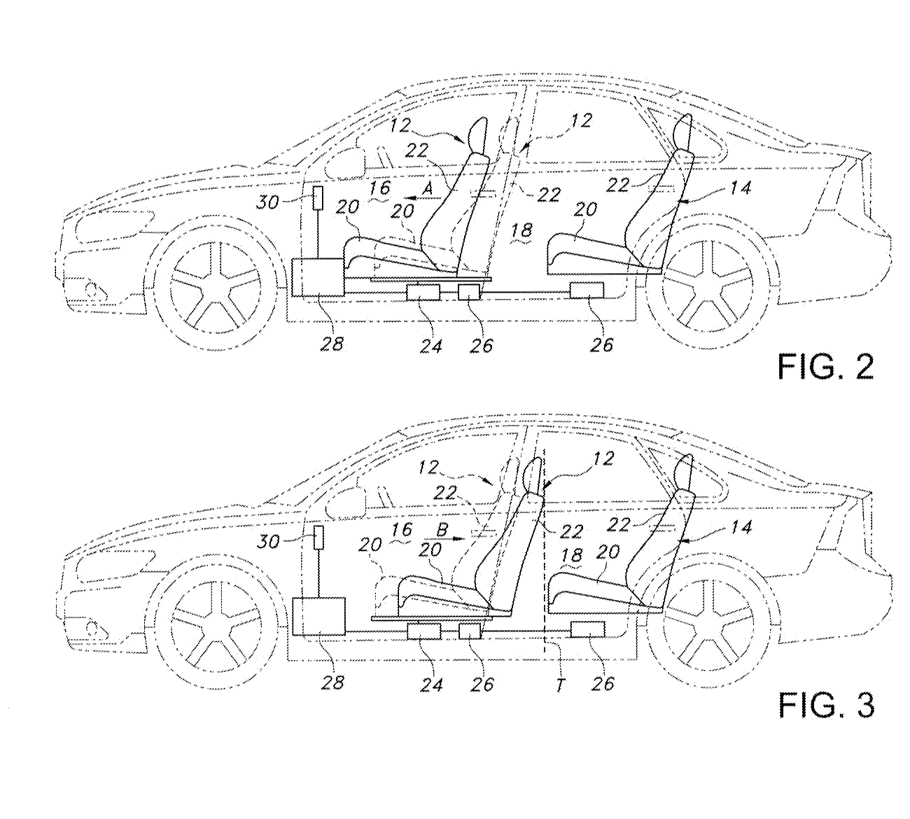

Turning now to FIGS. 2 and 3 depicting a seat repositioning system according to the present disclosure, it will be appreciated that like features to those of FIG. 1 are provided with like reference numerals. In addition to the features described above, the system controller 28 is configured to control a position of the vehicle front seat(s) 12 according to whether a rear seat 14 easy entry/exit feature of controller 28 is activated.

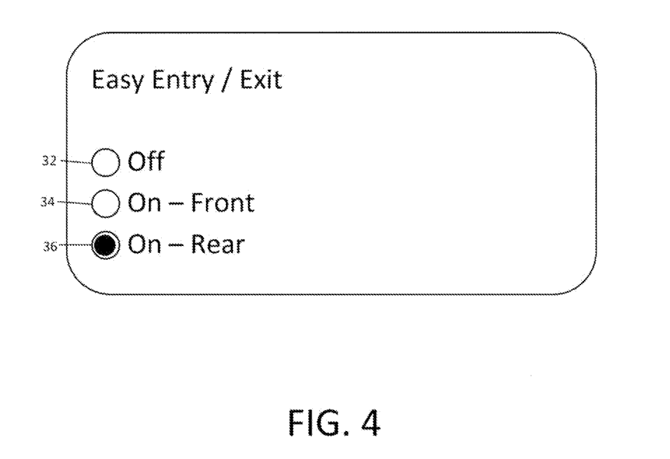

An actuator 30 is provided, configured to enable or disable the rear seat easy entry/exit feature as will be described in greater detail below. The actuator may be as simple as a switch or interface. A non-limiting example of a representative interface is shown in FIG. 4, and may be a manually actuated menu including an off button 32, a “front on” button 34 for enabling a front seat 12 easy entry/exit feature, and a “rear on” button 36 for enabling a rear seat 14 easy entry/exit feature. Of course, alternative embodiments of actuator 30 are contemplated. For example, a key fob (not shown) preprogrammed with a user's information and preferences may be configured to automatically enable or disable the front seat 12 easy entry/exit feature or the rear seat 14 easy entry/exit feature according to the identity of the user carrying the key fob. Thus, if a driver's key fob having a front seat 12 easy entry/exit option selected is detected in the vehicle 10, the front seat 12 easy entry/exit feature is automatically enabled. If, on the other hand, a different driver's key fob having a rear seat 14 easy entry/exit option selected is detected in the vehicle 10, the rear seat 14 easy entry/exit feature is automatically enabled and the front seat 12 easy entry/exit feature is disabled or limited as will be described in greater detail below.

Turning back to FIG. 2, at a high level when enabled the described seat repositioning system providing a rear seat 14 easy entry/exit function, by controller 28, controls the movement of front seat 12. For example, when the rear seat 14 easy entry/exit feature is enabled, if front seat sensor 24 indicates that there is no occupant of front seat 12, controller 28 causes front seat 12 to displace in a forward direction (see arrow A). Alternatively, if there is an occupant of front seat 12, controller 28 may prevent or at least limit forward movement of front seat 12.

Likewise, when the rear seat 14 easy entry/exit feature is enabled, rear seat door state sensor 26 may output a signal indicative of an open rear door 18, which could mean that a passenger wishes to enter/exit the vehicle 10. This condition would likewise cause controller 28 to displace front seat 12 in a forward direction (arrow A) as described above if front seat sensor 24 indicates that there is no occupant of front seat 12.

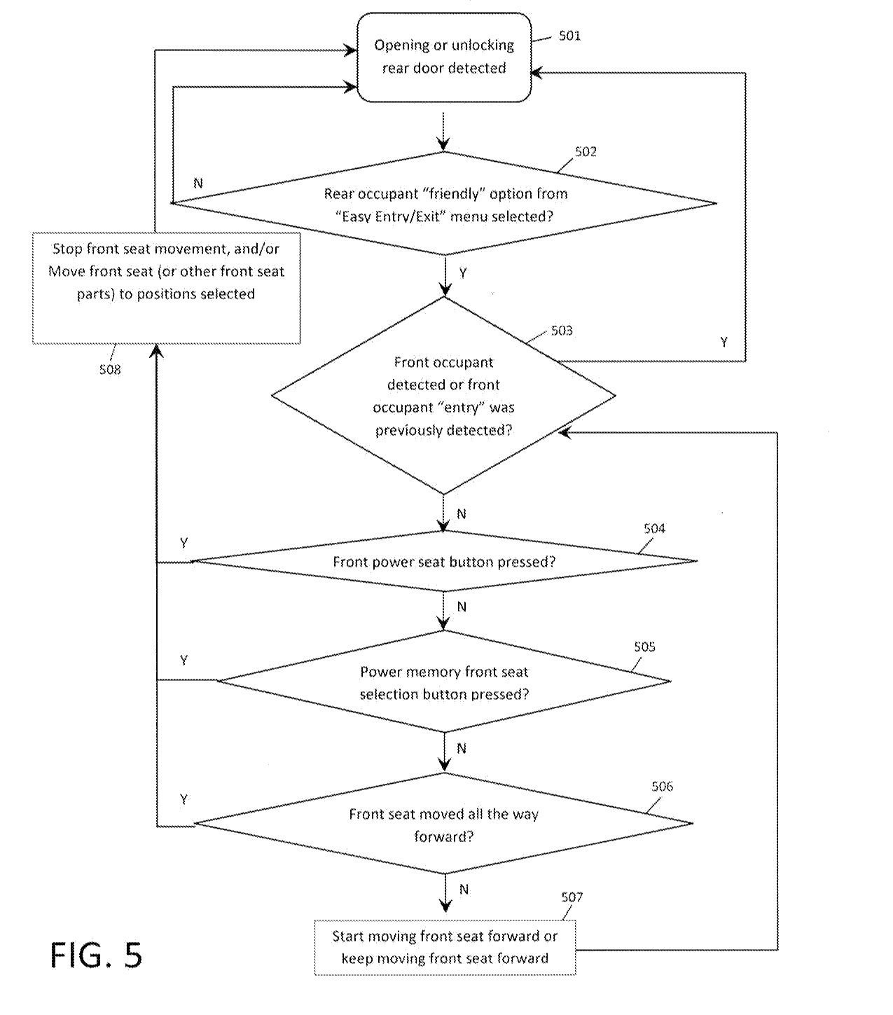

This is shown in greater detail in flow chart form in FIG. 5. At step 501, detection of a key fob in or near the vehicle or an opening or unlocking of a rear door 18 is determined by the mechanisms described above. If the rear easy/entry feature is enabled (step 502), a determination is made of whether the front seat 12 is occupied (step 503). If so, the system prevents movement of the front seat 12 in any direction, or returns to its original state.

If not, determinations are made of whether a user is attempting to move the front seat 12, such as whether the front seat 12 power button has been actuated (step 504), the front seat 12 power memory settings or presets have been detected (step 505), and if the front seat 12 has been moved as far in a forward direction as possible (step 506). If the answer to these questions is “no,” controller 28 causes front seat 12 to move fully forward (step 507). If the answer to any of these questions is “yes,” controller 28 stops movement of front seat 12 and/or moves front seat 12 to a predetermined position (step 508).

Alternatively or in addition to the above, controller 28 may also be configured to allow only a limited rearward movement of front seat 12 when the rear seat easy entry/exit feature is enabled. As a nonlimiting example, it is known to provide a front seat 12 configured to move in a rearward direction under certain conditions such as when the vehicle 10 ignition is placed in the “off” position, when a driver opens front door 12 to enter the vehicle, etc., to provide easier entry to/exit from the vehicle front seat 12. With reference to FIG. 3, in a situation where the rear seat 14 easy entry/exit feature is enabled and/or a rear door 18 is unlocked and/or opened (determined by a signal output from rear door state sensor 26), controller 28 may be configured to allow only a limited rearward movement of front seat 12 to a predetermined/preset threshold position T. In this way, at least a portion of the front seat 12 easy entry/exit feature is preserved, while still providing the rear seat 14 easy entry/exit benefits to the rear seat 14 passenger(s) as summarized above.

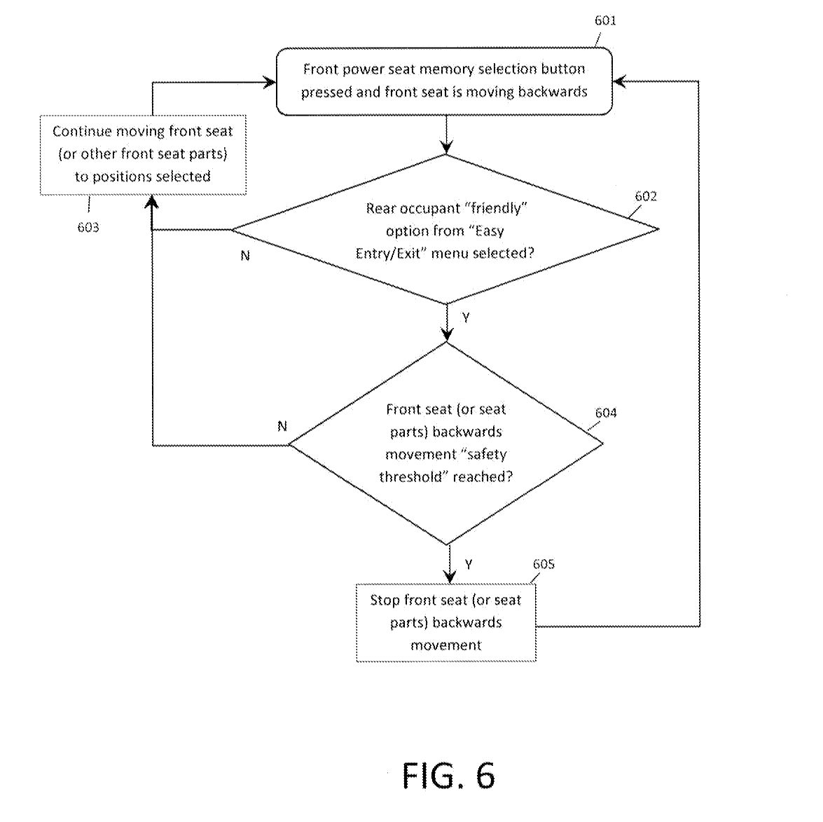

This latter feature is shown in greater detail in flow chart form in FIG. 6. At step 601, the front seat 12 power button has been activated (or the vehicle presets are causing the front seat 12 to move), and the front seat 12 is moving in a rearward direction (see arrow B of FIG. 3). At step 602, a determination is made whether the rear seat 14 easy entry/exit feature is activated. If not, the movement of front seat 12 continues (step 603). If so, a determination of whether a predetermined threshold T (see FIG. 3) has been reached by front seat 12. If not, the movement of front seat 12 continues (step 604). If so, rearward movement of front seat 12 is stopped by controller 28 (step 605).

While the foregoing description described forward and rearward movement of front seat 12, and mechanisms for controlling that movement to provide the described rear seat 14 easy entry/exit feature, of course alternative embodiments are possible and are contemplated herein. For example, the skilled artisan will readily appreciate that in addition to or as an alternative to the above, controller 28 may be configured also to activate existing mechanisms to fold front seat back 20 forward and/or restrict rearward movement of front seat back 12 under certain conditions. That is, when enabled the described rear seat 14 easy entry/exit feature, by controller 28, controls the movement of front seat 12 and/or front seat back 20. For example, the enabled rear seat 14 easy entry/exit feature, if front seat sensor 24 indicates that there is no occupant of front seat 12, by controller 28 causes front seat 12 to displace in a forward direction (see arrow A) and/or front seat back 20 to fold forwardly. Alternatively, if there is an occupant of front seat 12, controller 28 may prevent or at least limit forward movement of front seat 12 and may prevent forward folding of front seat back 20.

Likewise, rear seat door state sensor 26 may output a signal indicative of an open or unlocked rear door 18, which could mean that a passenger wishes to enter or exit the vehicle rear seat 14. This condition would likewise cause controller 28 to displace front seat 12 in a forward direction (arrow A) as described above, and/or to fold front seat back 20 forwardly.

In turn, controller 28 may also be configured to allow only a limited rearward movement of front seat back 20 under certain conditions. As discussed above, it is known to provide a front seat 12 configured to move in a rearward direction under certain conditions such as when the vehicle 10 motor is stopped, when a driver enters the vehicle, etc., to provide easier entry to/exit from the vehicle front seat 12. With reference to FIG. 3, in a situation where an occupant desires to move front seat 12 rearwardly to a preset position (arrow B) but the rear seat 14 easy entry/exit feature is enabled, controller 28 may be configured to allow only a limited rearward movement of front seat 12 and/or front seat back 20 to a pre-programmed or preset rear threshold T. Again, at least a portion of the normal movement of front seat 12 is preserved, while still providing the benefits to the rear seat 14 passenger(s) as summarized above.

Still yet other alternative embodiments are possible and contemplated. For example, as summarized above front and rear door sensors 26 may be configured to detect an open/closed state of front and rear doors 16, 18. Alternatively or in addition to this configuration, front and rear door sensors 26 may be provided that are configured to detect a locked/unlocked state of front and rear doors 16, 18. As will be appreciated, particularly in modern vehicles wherein as a safety feature the vehicle doors typically lock upon reaching a certain traveling speed or upon placing the transmission in drive, an unlocked rear door 14 may be indicative of an occupant desiring to enter or exit the stationary vehicle 10. Still more, while the drawings and descriptions herein are directed to four-door vehicles, the skilled artisan will appreciate that the described systems and methods are equally applicable to vehicles having only two doors, or more than four doors, with the caveat that the vehicle has at least one rear seat.

Obvious modifications and variations are possible in light of the above teachings. All such modifications and variations are within the scope of the appended claims when interpreted in accordance with the breadth to which they are fairly, legally and equitably entitled.

What is claimed:

1. A seat repositioning system for a vehicle, comprising an actuable position controller configured to automatically cause at least a portion of a displaceable front seat to move forwardly when a front seat occupant sensor associated with the front seat does not detect a front seat occupant.

2. The system of claim 1, wherein the position controller is further configured to, when enabled, prevent or limit a rearward movement of the displaceable front seat.

3. The system of claim 1, further including a rear door state sensor which outputs a signal to the position controller indicative of an open or unlocked state of a rear door of the vehicle.

4. The system of claim 1, further including an actuator configured for enabling or disabling the position controller.

5. The system of claim 4, wherein the actuator is one or more of a switch, a display console or instrument cluster menu button, and a key fob.

6. A vehicle including the system of claim 1.

7. A method for improving ease of entry to and/or exit from a rear seat of a vehicle, comprising:
providing an actuable position controller configured to automatically cause at least a portion of a displaceable front seat to move forwardly when at least one front seat occupant sensor does not detect a front seat occupant; and
by the position controller, causing the displaceable front seat to move forwardly.

8. The method of claim 7, further including configuring the position controller to, when enabled, prevent or limit rearward movement of the displaceable front seat; and
by the position controller, preventing or limiting rearward movement of the displaceable front seat.

9. The method of claim 7, further including providing a rear door state sensor which outputs a signal indicative of an open or unlocked state of a rear door of the vehicle.

10. The method of claim 9, further including providing an actuator configured for enabling or disabling the position controller.

11. The method of claim 10, including selecting an actuator from one or more of a switch, a display console or instrument cluster menu button, and a key fob.

12. A seat repositioning system for a vehicle, comprising:
at least one front seat occupant sensor;
a position controller configured to automatically cause at least a portion of a displaceable front seat to move forwardly when the at least one front seat occupant sensor does not detect a front seat occupant; and
an actuator configured for enabling or disabling the position controller.

13. The system of claim 12, further wherein the position controller causes at least a portion of a front seat of the vehicle to prevent or limit rearward movement of the displaceable front seat.

14. The system of claim 12, further including a rear door state sensor which outputs a signal indicative of an open or unlocked state of a rear door of the vehicle.

15. The system of claim 12, wherein the actuator is one or more of a switch, a display console or instrument cluster menu button, and a key fob.

16. A vehicle including the system of claim 12.
